(19) United States
(12) Patent Application Publication
(10) Pub. No.: US 2007/0082560 A1
(43) Pub. Date: Apr. 12, 2007

(54) Method and computer program product for assembling a plurality of pages together

(75) Inventor: Olivier Acher, Monts (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/266,335

(22) Filed: Nov. 4, 2005

(30) Foreign Application Priority Data
Oct. 11, 2005 (FR) FR 05 53081

(51) Int. Cl. H01R 13/187

(52) U.S. Cl. 439/845

(57) ABSTRACT

A method and computer program product for assembling sheets of paper include cutting at least one “female” cut motif having a female slit in a first sheet. For each female slit, the method and computer program product include cutting in a second sheet a “male” cut motif having a central portion and two cuts at either end of the central portion. Further, the method and computer program product include cutting in each other sheet at least one “female” motif or “male” motif such that other sheets all have the same motif. The method also includes assembling each of the sheets having the same motif with the sheet having a different motif by inserting the central portion of the “male” motif into the female slit of the “female” motif.

### CROSS-REFERENCE TO RELATED APPLICATIONS

The present application claims priority to French Patent Application No. FR 05 53081, filed Oct. 11, 2005, hereby incorporated by reference in its entirety, and is also related to U.S. patent application Ser. No. 10/507,217, filed Sep. 16, 2004, now published as U.S. Patent Publication No. 2005/0158107.

### FIELD OF THE INVENTION

The invention relates to a method and computer program product for preparing for assembly of at least two pages together to obtain a bound document. The invention can be applied to many disciplines which require a plurality of pages to be assembled to form a document, in particular in the secretarial field.

### DISCUSSION OF THE BACKGROUND

A large number of ways of connecting a plurality of pages to produce a complete document are known in the printing and publishing world. Particular techniques which may be mentioned are bookbinding, stapling, gluing, or the use of clipping means or mechanical retaining means which are positioned by means of perforations present in the paper (loose leaf file).

Such known solutions for connecting together the pages of a document necessitate the use of a consumable or a specific accessory (staple, paperclip, file, etc). However, the only equipment available may be a conventional office printer with no binding function (only expensive printers have such a function), and consumables or assembling accessories may not be to hand.

Further, the presence of such consumables or fixing accessories may be disadvantageous. As an example, unsightly staples in the document may have to be removed, or the use of paperclips may have to be avoided since they tend to slide from their fixing position and become lost. The presence of metallic elements such as paperclips or staples may also obstruct the use of a paper shredder (for destroying paper documents) when the bound document is to be destroyed.

### SUMMARY OF THE INVENTION

The present invention includes a simple way of assembling pages to form a complete document without requiring the use of conventional assembly means.

An embodiment of the invention includes the use of a cutter and printer device, for example a device to provide an “all paper” solution for assembling pages together, such as the devices disclosed in International Patent Application WO 2004/069542 A1 and U.S. patent application Ser. No. 10/507,217, each of which are incorporated by reference herein in their entirety.

Thus, an embodiment of the invention includes a method of preparing for assembling of at least two sheets of paper using a peripheral device comprising means for printing a sheet of paper, means for cutting the sheet of paper and means for receiving instructions. The method may include female cutting at least one “female” cut motif in the first sheet, such that each “female” cut motif has a female slit passing between a point A and a point B in the first sheet. The female slit may be located at a predetermined position close to an edge of the first sheet. The method may also include male cutting a “male” cut motif in a second sheet for each “female” cut motif formed in the female cutting, the “male” cut motif having a central portion defined by points C and D located on a line passing through points A and B of the corresponding female slit in the “female” cut motif. Further, a first male slit passes from point C towards an edge of the second sheet, and a second male slit passes from point D towards a periphery of the second sheet, and a distance separating point C from point D may be less than or equal to a distance separating point A from point B of the corresponding female slit in the “female” cut motif. In addition, if there are more than first and second sheets, the method may include cutting at least one “female” type motif or “male” type motif in each other sheet, the other sheets all having a same motif. The method may also include assembling each of the sheets having the same motif with the sheet having a different motif by inserting the central portion of the “male” cut motif into the female slit of the “female” cut motif.

The actual assembling of the sheets may be performed manually by a user or with the assistance of an assembly tool.

The term “slit” means a cut formed within the surface area of a sheet in the form of a slit, with an uncut space on either side of the cut. Preferably, the length of the space is 5 mm (millimeters) or more. As an example, cutting the slit is stopped at a distance of 5 mm or more from one of the edges of the sheet.

The two cuts at either end of the central “male” cut motif allow tabs to be formed which may be inserted into the slit of the “female” cut motif and may prevent the “male” motif from coming out of the “female” cut motif.

Preferably, the cuts are positioned in an unprinted region (no text, figures, etc) of the sheet, for example in the margin beyond the printed text, so that the presence of the cuts does not interfere with reading the printed sheets.

It is possible for a single sheet to comprise one or more “female” type cut motifs and for all of the other sheets to comprise one or more “male” type cut motifs, or vice versa, and for the sheet comprising the unique motif type to constitute the first page of the assembled document or the last page of the document.

In a preferred embodiment, the assembly method also may include a step of forming at least one fold line using the cutter means of the peripheral device, starting from point C and/or point D and passing towards the edge of the second sheet to facilitate inserting the “male” cut into the “female” cut, the sheet being folded along the fold line or lines. It should be recalled that the fold is a cut partly through the thickness of the sheet, for example, half way through the sheet.

Preferably, the fold line starting from point C (point D) forms an obtuse angle with the cut starting from point C (point D), the obtuse angle being in the range 90° to 135°. This angle allows the “male” cut motif to be inserted readily (for example by sliding) into the “female” cut motif by manually folding the sheet comprising the “male” motif along the fold lines. Once inserted, the “male” cut motif may be unfolded so that the “male” cut motif forms tabs which prevent the “male” motif from escaping from the “female” motif.

In a variation, the “male” cut motif includes two fold lines, a fold line starting from point C and a fold line starting from point D.

In a preferred embodiment, the assembly method may include a step of forming at least one cut starting from the female motif in the form of a slit from a point located between points A and B and passing towards the outside of the sheet.

In a first variation, the slit comprises a single cut located equidistantly from point A and point B.

In a second variation, the slit comprises two cuts, a first cut starting from a point A′ located on the slit and the second cut starting from a point B′ located on the slit, the distances AA′ and BB′ being equal.

In a variation, the margin, i.e. the space between the line of cut and a printed zone, for two consecutive sheets may be less than or equal to the thickness of one of the two sheets. The margin may also be zero. This thereby creates a “gutter free” effect which is particularly elegant and may, for example, be provided for a photograph, an illustration or a large table printed over a double page.

In a preferred embodiment, the predetermined position of the at least one “female” cut motif may also be located close to a corner of the sheet. The term “corner” means the position where two adjacent edges of a sheet meet.

In a preferred embodiment, the slit of the “female” cut motif may be a straight line passing from point A to point B. Alternatively, all of the cuts may be straight lines or curves.

In a preferred embodiment, the cut or cuts on each sheet may be produced by printing the motif for the cut onto the sheet in question using an absorbent ink which is capable of penetrating deep into the sheet of paper, then by exposing the sheet to a low power laser beam emitted, as a function of received instructions, at a wavelength absorbed by the positions inked with absorbent ink, the power of the laser being sufficient to cut the sheet of paper at the inked positions.

In a preferred embodiment, the at least one fold line on a sheet may be produced by printing the at least one fold line onto the sheet in question using an absorbent ink which is capable of penetrating deep into the sheet of paper, then by exposing the sheet to a low power laser beam emitted, as a function of received instructions, at a wavelength absorbed by the positions inked with absorbent ink, the power of the laser being sufficient to obtain partial ablation of the paper at the positions inked with absorbent ink.

Partial ablation of the paper enables the sheet of paper to be folded easily at the fold line but without cutting the sheet of paper at the fold line.

In the preferred embodiment, the laser is one of the lasers in a matrix comprising a plurality of lasers, each laser being individually controlled. Instead of using a single laser, it is also possible to use a matrix of lasers, i.e. a matrix comprising a plurality of lasers, with each laser of the matrix being controlled individually so as to emit radiation on passing over a zone that is to be ablated. Thus, it is possible to perform the paper-cutting operations during a scan that is also used for printing on the sheet of paper. Such a matrix may comprise one or several hundreds of laser diodes. For example it may be made by assembling together a plurality of strips of diodes. The use of a matrix of lasers instead of a single laser thus may make it possible to avoid cutting taking place in a paper-handling stage subsequent to the inking stage, and consists in tracking the lines of cut on the paper using the matrix of lasers by causing the matrix of lasers to move together with the paper. It is thus possible to perform cutting in a “constant speed scanning” mode, which is the mode commonly used for the inking stage. It is thus possible to perform inking and cutting during the same paper-cutting stage. Total or partial cutting of the paper is thus obtained by one or more scans of the matrix of lasers over the sheet of paper.

In a preferred embodiment, the at least one fold line on a sheet may be produced by mechanically cutting it half way through, for example using a cutter blade.

In a preferred embodiment, at least one of the sheets to be assembled may be printed using printer means of the device. Printing may take place before or after the step of producing the cuts or fold lines on the sheet.

### BRIEF DESCRIPTION OF THE DRAWINGS

The invention will be better understood, and other advantages and features will become apparent, from the following description given by way of non limiting example made with reference to the accompanying drawings in which:

FIGS. 1a and 1b show a top view of steps in producing a “female” type cut motif in a first sheet and in producing a “male” type cut in a second sheet to assemble the two sheets in accordance with a first embodiment of the invention;

FIG. 2 shows a variation of the FIG. 1b;

FIG. 3 shows a variation of the FIG. 1a;

FIGS. 4a and 4b show a top view of steps in producing two “female” type cut motif in a first sheet and two “male” type cut motif in a second sheet to assemble the two sheets in accordance with a second embodiment of the invention;

FIGS. 5a and 5b show a top view of steps in producing a “female” type cut motif in the corner of a first sheet and in producing a “male” type cut in the corner of a second sheet to assemble the two sheets in accordance with a third embodiment of the invention;

FIG. 6 shows a variation of the FIG. 5a; and

FIG. 7 shows a variation of the FIG. 5b.

### DESCRIPTION OF THE PREFERRED EMBODIMENTS

A plurality of sheets may be assembled to form a document by producing cuts along one edge of the sheets (long edge of the sheet or short edge of the sheet) or close to a corner of the sheets.

The sheets used may, for example, be sheets in A4 or “US legal” format (American format), routinely used in printers. However, the present invention is not limited to those size sheets and applies equally to other size sheets.

The description begins with various assemblies made along the long edge of the sheets. The invention applies as well to similar assemblies made along a short edge or an equal length edge of the sheets.

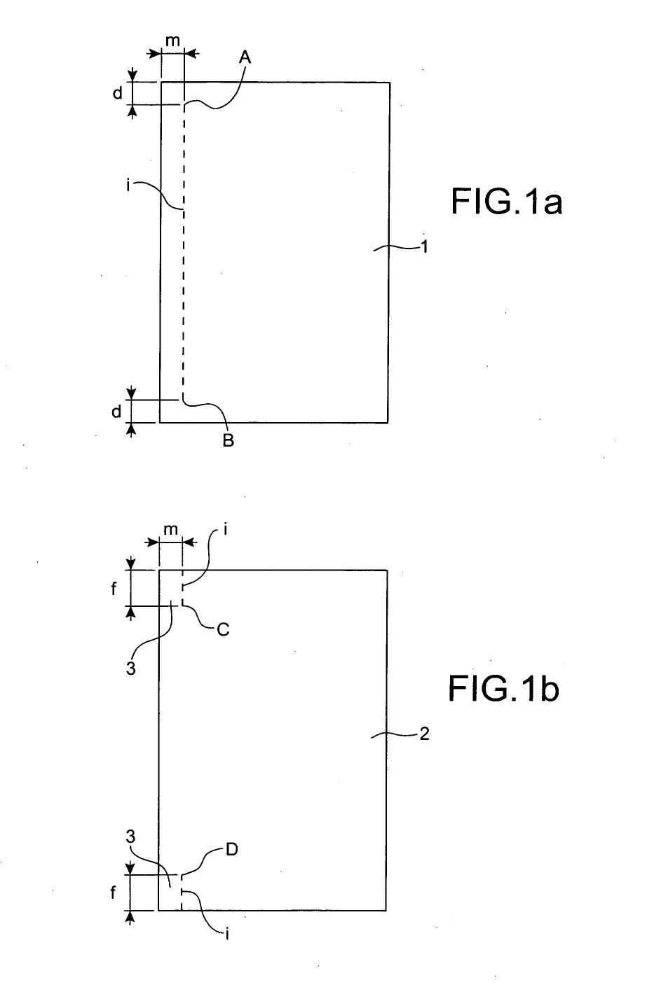

To assemble two sheets 1 and 2, a slit (female type cut motif) is produced in a first sheet 1 (see FIG. 1a).

Here, the slit is a straight line AB, shown as a line of cut i in dashed lines, and the slit is positioned parallel to the left hand edge of the sheet 1 along the long edge of the sheet at a distance m from the left hand edge. As an example, the distance m is 1.5 cm (centimeters). Preferably, the slit is positioned so that there is an uncut space d beyond each of the ends A and B. Alternatively, the space beyond the end B may be different than the space beyond end A. In this example, a 2 cm space is left beyond the ends of the slit.

In the second sheet 2 (see FIG. 1b), a first cut i (dashed line) is produced a distance m from the left hand edge of the sheet 2, starting from a point C and reaching the top edge of the sheet 2, parallel to the left hand edge of the sheet, and a second cut i starting from point D and reaching the bottom edge of the sheet parallel to the left hand edge of the sheet (see FIG. 1b). This forms two tabs 3 in the sheet 2. The point C (the point D) is located at a distance f from the top (bottom) edge of the sheet. The distance f is deliberately slightly longer than the distance d (for example 2.2 cm) so that the central portion between the points C and D can pass into the space between the points A and B of the slit. The distance m (distance from the left hand edge) can be deliberately identical for both sheets so that the assembled sheets match up.

Subsequently, the first sheet is assembled with the second sheet by inserting the central portion CD into slit AB or, in other words, by inserting the tabs 3 of the second sheet 2 into the slit of the first sheet 1.

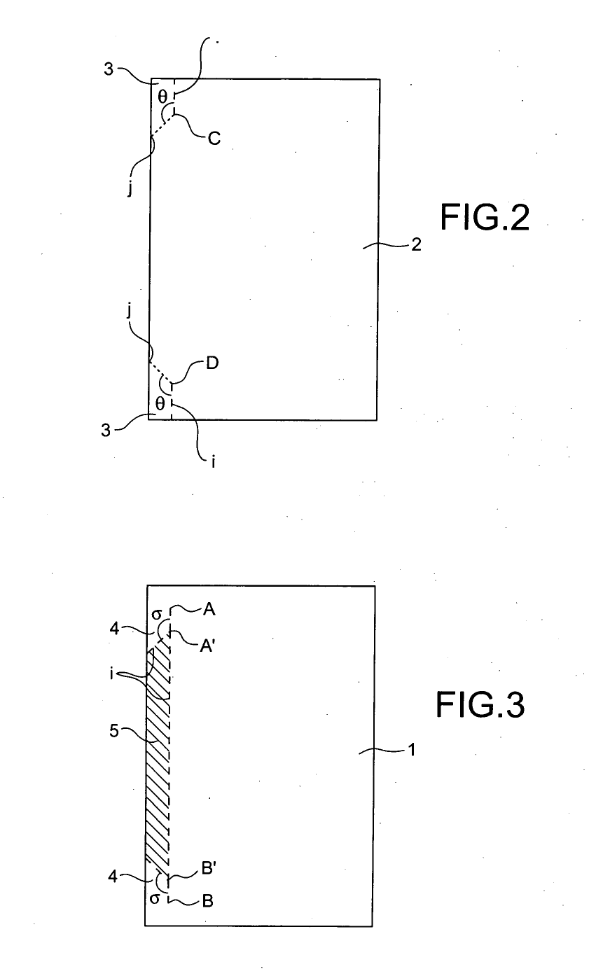

To facilitate inserting the central portion CD into the slit AB, fold lines j (dotted lines) may be produced, for example a fold line j starting from point C and in a straight line towards the left hand edge of the sheet 2, forming an angle θ of 135° with the cut i starting from the point C, and a fold line j starting from the point. D and passing in a straight line towards the left hand edge of the sheet 2 forming an angle of 135° with the cut i starting from the point D (see FIG. 2). A fold is formed along these fold lines before inserting the central portion CD into the slit AB, then the sheet 2 is unfolded so that the tabs 3 prevent the central portion CD from escaping from the slit AB.

A further means for facilitating inserting the central portion CD into the slit AB is to produce cuts i starting from the slit AB. As an example, in FIG. 3, a first cut i is produced starting from a point A′ located on the slit and passing towards the left hand edge of the sheet 1, and a second cut i starting from a point B′ located on the slit and passing towards the left hand edge of the sheet 1. Thus, two tabs 4 are formed and the cut out portion 5 located between the tabs 4 (hatched zone) is removed. Preferably, the distances AA′ and BB′ are deliberately sufficiently large so that the tabs 4 can hold the central portion CD in place in the slit. Preferably, the distances AA′ and BB′ are equal. In FIG. 3, an angle σ of 135° is formed between the line of cut i starting from point A′ (B′) and the line AA′ (BB′).

The solutions may also be combined to provide fold lines at points C and D along with cuts at the slit.

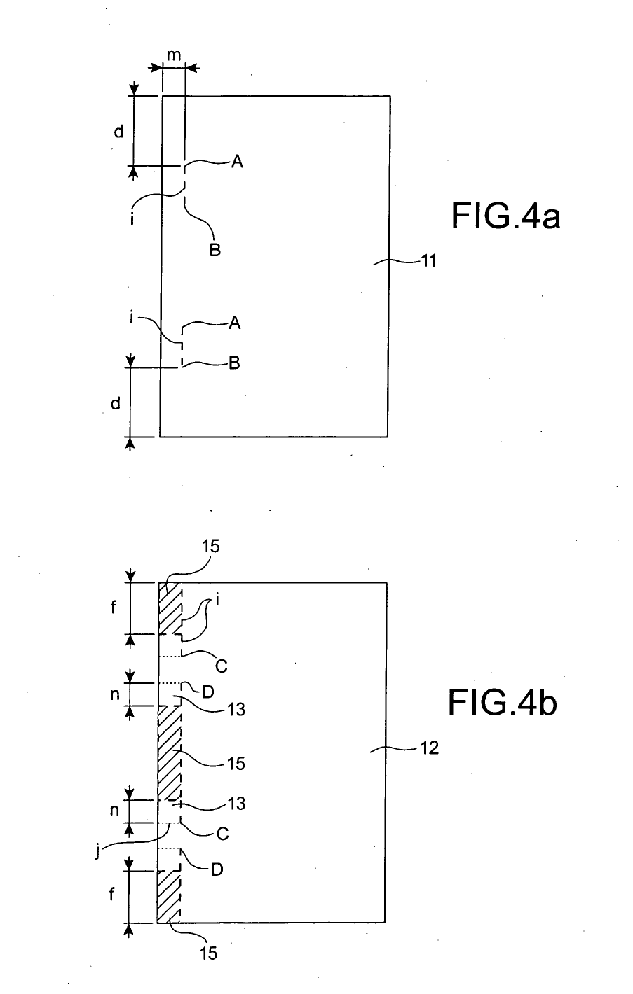

It is also possible to provide more than one slit on a sheet 11 and the same number of “male” type cut motifs associated with slits on the second sheet 12. As an example, it is possible to provide two slits on one sheet 11 placed parallel and at a distance m from the left hand edge of the sheet 11 (FIG. 4a) and on another sheet 12, to provide two “male” cut motifs associated with the slits (FIG. 4b). Each “male” cut motif preferably includes a fold line j starting from point C (point D) and passing to the left hand edge of the sheet 12 at an angle of 90°, as well as a cut i at a distance n from point C (point D) which is less than the distance f which separates the point C (the point D) from the edge of the sheet 12, passing to the left hand edge and forming an angle of 90°. The supplemental cuts i form portions 15 to be removed (hatched zones).

In the same manner, more than two sheets may be assembled by reproducing the cut motif or motifs of one sheet on other sheets and by assembling the sheets comprising one or more motifs of the same type with the sheet comprising one or more motifs of the other type, for example by assembling three sheets comprising two “male” type cut motifs with one sheet comprising two “female” type cut motifs. Further, the sheet comprising a cut motif (male or female) which is unique relative to the other sheets may be the first sheet of the document (“front cover”) or the last (“back cover”).

Pages can also be assembled using one of the corners of the sheets.

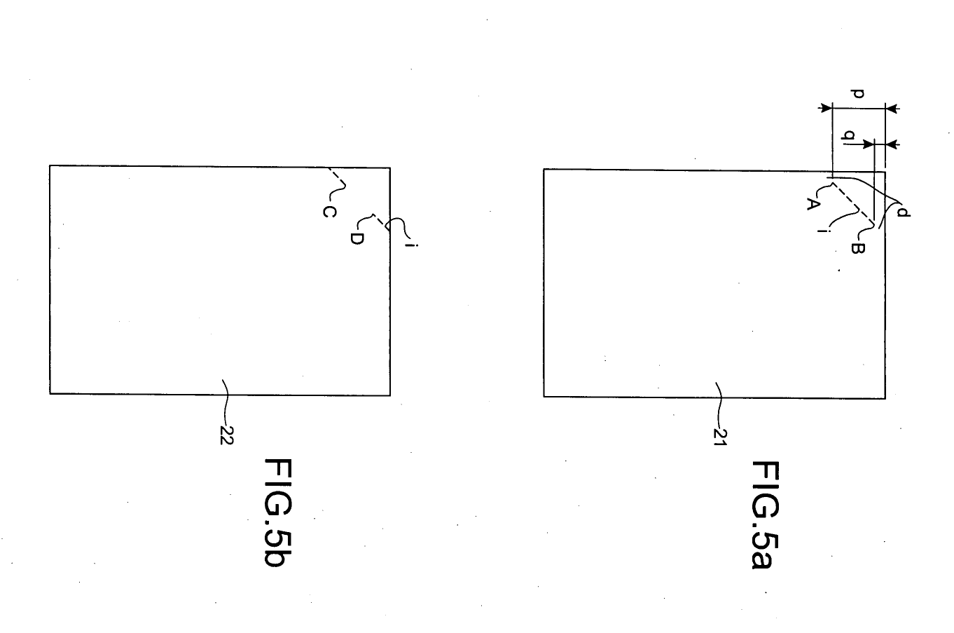

As an example, FIG. 5a shows a slit formed close to the top left hand corner of a sheet 21. The slit is a straight line connecting points A and B, point A being at a distance p from the top edge of the sheet and point B at a distance q from the top edge of the sheet 21. This slit is associated with a “male” cut motif formed on another sheet (see FIG. 5b), the motif comprising two cuts i either side of a central portion CD with a length the same size or shorter than the distance separating points A and B, points C and D being located on a line CD at the same level as the line AB.

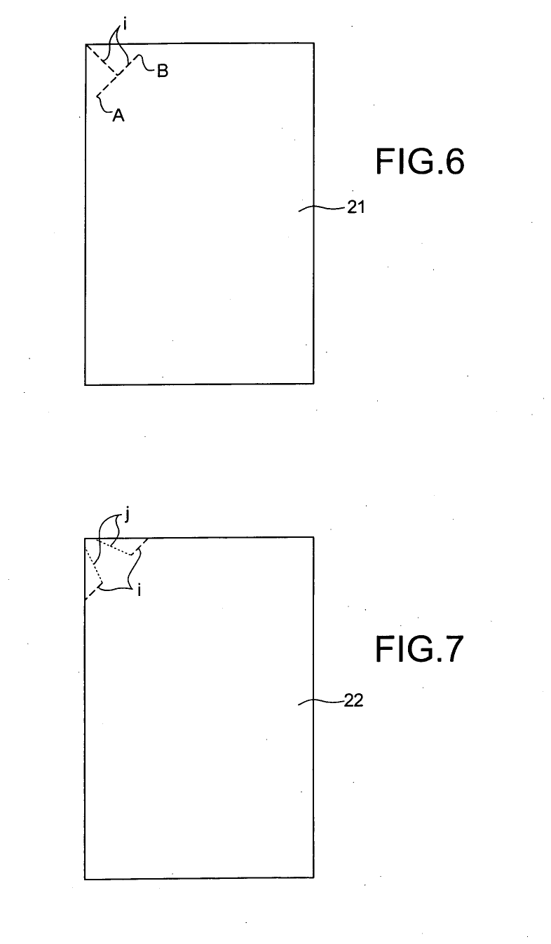

The slit AB may comprise a cut i, for example a cut perpendicular to the slit AB (see FIG. 6) and/or the “male” cut motif may comprise fold lines j, for example a fold line starting from point C and a fold line starting from point D (see FIG. 7).

In order to produce the cut motifs and fold lines described above, a printer and cutter device such as that described in International Patent Application WO 2004/069542 A1 and U.S. patent application Ser. No. 10/507,217 may be used. The lines of cut (for example to produce the cut motifs) may be obtained by printing the lines of cut on each sheet of paper with an absorbent ink, and by exposing each sheet to a laser beam emitted at a wavelength absorbed by the regions inked with absorbent ink. The laser is a low power laser, but has sufficient power to achieve ablation which is total (along the lines of cut) or partial (along the fold lines) of the paper. The characteristics of this absorbent ink and the laser are described in International Patent Application WO 2004/069542 A1 and U.S. patent application Ser. No. 10/507,217.

Preferably, word processing software or printer driver software is used to define the positions of the cut motifs, their dimensions and their arrangements on the various sheets to properly position the motifs used for assembly and to produce sheets which can readily be assembled. In particular, the document pagination and paper thickness may be used by the word processing software or the software associated with the printer and cutter device to define the position of the cut motifs on each sheet. Thus, a computer and software may be used to correctly position the printed contents of each sheet (text, drawings, illustrations, etc) with the positioning of the “male” and “female” type cut motifs and the supplemental fold and/or lines of cut. The software renders easy the use of a printer and cutter device such as that described in International Patent Application WO 2004/069542 A1 and U.S. patent application Ser. No. 10/507,217 and can produce both the cuts used to assemble the sheets and can print the sheets with one and the same device.

The software allows the dimensions of the margin, i.e. the space between the lines of cut and the printed zone, to be set correctly as required by the desired result. As an example, the software may produce a zero value for the margin in order to be able to position and print a large photograph over two consecutive sheets.

The “all paper” assembly solution proposed by the invention renders redundant the use of the usual fixing means such as staples or paperclips. It thereby produces bound sheets which can be destroyed by being passed through a shredder without firstly having to remove the fixing means.

An embodiment of the present invention may also include a computer program product suitable for being received on a storage medium and including instructions capable of being used for programming a computer in such a manner as to perform the method of the present invention. The storage medium may include, but is not limited to: any type of disk including floppy disks, optical disks, CD-ROMs, magneto-optical disks, ROMs, RAMs, EPROMs, EEPROMs, instantaneous memories (“flash memories), magnetic or optical cards, or any type of medium suitable for storing electronic instructions.

The invention may also advantageously be used with a conventional program programmed in compliance with the teaching of the present specifications, as will be apparent to a person skilled in the art working in the field of computers. Appropriate coding of software can be prepared by competent programmers on the basis of the teaching in the present description, as will be apparent to a person skilled in the art working in the field of software. In particular, the computer program for cutting and printing in accordance with the present invention can be written in a variety of programming languages, including but not restricted to: C, C++, Fortran, and Basic, as will be apparent to the person skilled in the art having ordinary competence in this field. The invention may also be put into application by preparing application-specific integrated circuits or by connecting together a suitable network of conventional circuit components, as will be apparent to the person skilled in the art.

Thus, an embodiment of the present invention also includes a computer-based product that may be hosted on a storage medium and include instructions that can be used to program a computer to perform a process in accordance with the present invention. In particular, the computer program product according to the present invention can store a program, which, when executed by a computer, causes the computer to control a device to form cut motifs as discussed above, examples of which are shown in FIGS. 1-7 of the present document. The device can be a peripheral device, such as the one disclosed in U.S. patent application Ser. No. 10/507,217, now published as US 2005/0158107, which is hereby incorporated by reference. The storage medium can include, but is not limited to, any type of disk including floppy disks, optical disks, CD-ROM, magneto-optical disks, ROMs, RAMs, EPROMs, EEPROMs, Flash Memory, Magnetic or Optical Cards, or any type of media suitable for storing electronic instructions.

This invention may also be conveniently implemented using a conventional general purpose digital computer programmed according to the teachings of the present specification, as will be apparent to those skilled in the computer art. Appropriate software coding can readily be prepared by skilled programmers based on the teachings of the present disclosure as will be apparent to those skilled in the software art. In particular, the computer program product for assembling sheets according to the present invention can be written in a number of computer languages including but not limited to C, C⁺⁺, Fortran, and Basic, as would be recognized by those of ordinary skill in the art. The invention may also be implemented by the preparation of applications specific integrated circuits or by interconnecting an appropriate network of conventional component circuits, as will be readily apparent to those skilled in the art.

1. A method of assembling at least first and second sheets of paper, the method comprising the following steps:
female cutting at least one “female” cut motif in the first sheet, each “female” cut motif having a female slit between a point A and a point B in the first sheet, the female slit being located at a predetermined position close to an edge of the first sheet; and
male cutting a “male” cut motif in a second sheet for each “female” cut motif formed in the female cutting step, the “male” cut motif having a central portion defined by points C and D located on a line extending through points corresponding to points A and B in the “female” cut motif, a first male slit extending from the point C towards an edge of the second sheet, and a second male slit extending from the point D towards a periphery of the second sheet, a distance separating the point C from the point D being less than or equal to a distance separating the point A from the point B of the corresponding female slit in the “female” cut motif.

2. The method according to claim 1, further comprising forming at least one fold line in the “male” cut motif from the point C or the point D and extending towards the edge of the second sheet.

3. The method according to claim 2, wherein the at least one fold line forms an obtuse angle with the first male slit or the second male slit, the obtuse angle being in a range 90° to 135°.

4. The method according to claim 2, wherein the at least one fold line in the “male” cut motif includes two fold lines.

5. The method according to claim 1, further comprising cutting at least one additional female slit in the “female” cut motif from a point located between the points A and B and extending towards a periphery of the first sheet.

6. The method according to claim 5, wherein the cutting at least one additional female slit comprises cutting a single additional female slit from the point located between the points A and B and located equidistantly from the point A and the point B.

7. The method according to claim 5, wherein the cutting at least one additional female slit comprises cutting a first additional female slit from a point A′ located between the points A and B and a second additional female slit from a point B′ located between the points A and B, a distance between the points A and A′ being equal to a distance between the points B and B′.

8. The method according to claim 1, wherein a separation between each of the first and second male slits and a printed zone for two consecutive sheets is less than or equal to a thickness of one of the two consecutive sheets.

9. The method according to claim 1, wherein the predetermined position of the female slit in the at least one “female” cut motif is located close to a corner of the first sheet.

10. The method according to claim 1, wherein the female slit of the “female” cut motif is a straight slit extending from the point A to the point B.

11. The method according to claim 1, wherein each cutting step further comprises:
printing with an absorbent ink capable of penetrating into each sheet; and
exposing each sheet to a laser beam emitted, as a function of received instructions, at a wavelength absorbed by the absorbent ink, a power of the laser beam being sufficient to cut through each sheet where the absorbent ink is printed.

12. The method according to claim 2, wherein the forming at least one fold line in the “male” cut motif further comprises:
printing the at least one fold line onto each second sheet and each other sheet having the “male” cut motif using an absorbent ink capable of penetrating into each second sheet and each other sheet having the “male” cut motif; and
exposing each second sheet and each other sheet having the “male” cut motif to a laser beam emitted at a wavelength absorbed by the absorbent ink, a power of the laser beam being sufficient to partially ablate each second sheet and each other sheet having the “male” cut motif where the absorbent ink is printed.

13. The method according to claim 12, wherein the laser beam is produced by a laser in a laser matrix comprising a plurality of lasers, each laser being configured to be controlled independently of other lasers in the plurality of lasers.

14. The method according to claim 1, wherein at least one of the sheets to be assembled is printed using a printing section of a peripheral device.

15. The method of claim 14, wherein the peripheral device further comprises a cutting section configured to cut a sheet of paper and a receiving section configured to receive instructions.

16. The method of claim 1, wherein the male cutting step further comprises cutting the first male slit extending from the point C towards the edge of the second sheet, and the second male slit extending from the point D towards the edge of the second sheet.

17. The method of claim 1, wherein the male cutting step further comprises cutting the first male slit extending from the point C towards the edge of the second sheet, and the second male slit extending from the point D towards another edge of the second sheet.

18. The method of claim 1, further comprising manually assembling each sheet having a same cut motif with each sheet having a different motif by inserting the central portion of the “male” cut motif into the female slit of the “female” cut motif.

19. The method of claim 1, further comprising cutting at least one “female” cut motif or “male” cut motif in sheets other than said first and second sheets, the other sheets all having a same cut motif.

20. The method of claim 1, further comprising assembling each sheet by inserting the central portion of the “male” cut motif into the female slit of the “female” cut motif.

21. A computer program product storing a program to prepare assembly of at least first and second sheets of paper which when executed by a computer causes a device to perform the following steps:
female cutting at least one “female” cut motif in the first sheet, each “female” cut motif having a female slit between a point A and a point B in the first sheet, the female slit being located at a predetermined position close to an edge of the first sheet; and
male cutting a “male” cut motif in a second sheet for each “female” cut motif formed in the female cutting step, the “male” cut motif having a central portion defined by points C and D located on a line extending through points corresponding to the points A and B in the “female” cut motif, a first male slit extending from the point C towards an edge of the second sheet, and a second male slit extending from the point D towards a periphery of the second sheet, a distance separating the point C from the point D being less than or equal to a distance separating the point A from the point B of the corresponding female slit in the “female” cut motif.

22. The computer program product according to claim 21, the computer program causing the device to perform a step of forming at least one fold line in the “male” cut motif from the point C or the point D and extending towards the edge of the second sheet.

23. The computer program product according to claim 22 wherein the at least one fold line forms an obtuse angle with the first male slit or the second male slit, the obtuse angle being in a range 90° to 135°.

24. The computer program product according to claim 22, wherein the at least one fold line in the “male” cut motif includes two fold lines.

25. The computer program product according to claim 21, the computer program causing the device to perform a step of cutting at least one additional female slit in the “female” cut motif from a point located between the points A and B and extending towards a periphery of the first sheet.

26. The computer program product according to claim 25, wherein the cutting at least one additional female slit comprises cutting a single additional female slit from the point located between the points A and B and located equidistantly from the point A and the point B.

27. The computer program product according to claim 25, wherein the cutting at least one additional female slit comprises cutting a first additional female slit from a point A′ located between the points A and B and a second additional female slit from a point B′ located between the points A and B, a distance between the points A and A′ being equal to a distance between the points B and B′.

28. The computer program product according to claim 21, wherein a separation between each of the first and second male slits and a printed zone for two consecutive sheets is less than or equal to a thickness of one of the two consecutive sheets.

29. The computer program product according to claim 21, wherein the predetermined position of the female slit in the at least one “female” cut motif is located close to a corner of the first sheet.

30. The computer program product according to claim 21, wherein the female slit of the “female” cut motif is a straight slit extending from the point A to the point B.

31. The computer program product according to claim 21, wherein the program, when executed by the computer, causes the device to perform:
printing with an absorbent ink capable of penetrating into each sheet; and
exposing each sheet to a laser beam emitted, as a function of received instructions, at a wavelength absorbed by the absorbent ink, a power of the laser beam being sufficient to cut through each sheet where the absorbent ink is printed.

32. The computer program product according to claim 22, wherein the program, when executed by the computer, causes the device to perform the forming at least one fold line in the “male” cut motif by:
printing the at least one fold line onto each second sheet and each other sheet having the “male” cut motif using an absorbent ink capable of penetrating into each second sheet and each other sheet having the “male” cut motif; and
exposing each second sheet and each other sheet having the “male” cut motif to a laser beam emitted at a wavelength absorbed by the absorbent ink, a power of the laser beam being sufficient to partially ablate each second sheet and each other sheet having the “male” cut motif where the absorbent ink is printed.

33. The computer program product according to claim 21, wherein at least one of the sheets to be assembled is printed using a printing section of the device.

34. The computer program product of claim 33, wherein the device further comprises a cutting section configured to cut the sheet of paper and a receiving section configured to receive instructions.

35. The computer program product of claim 21, wherein the program, when executed by the computer, causes the device to perform the cutting the “male” cut motif by cutting the first male slit extending from the point C towards the edge of the second sheet, and the second male slit extending from the point D towards the edge of the second sheet.

36. The computer program product of claim 21, wherein the program, when executed by the computer, causes the device to perform the cutting the “male” cut motif by cutting the first male slit extending from the point C towards the edge of the second sheet, and the second male slit extending from the point D towards another edge of the second sheet.

37. The computer program product of claim 21, wherein the program, when executed by the computer, causes the device to perform cutting at least one “female” cut motif or “male” cut motif in sheets other than said first and second sheets, the other sheets all having a same cut motif.

38. The computer program product of claim 31, wherein the laser beam is produced by a laser in a laser matrix comprising a plurality of lasers, each laser being configured to be controlled independently of all other lasers in the plurality of lasers.
